(19) United States
(12) Patent Application Publication
(10) Pub. No.: US 2025/0056396 A1
(43) Pub. Date: Feb. 13, 2025

(54) METHOD AND APPARATUS FOR IMPROVEMENTS IN AND RELATING TO SLICE MANAGEMENT IN A WIRELESS COMMUNICATION SYSTEMS

(71) Applicant: SAMSUNG ELECTRONICS CO., LTD., Suwon-si (KR)

(72) Inventors: Mahmoud WATFA, Staines (GB); Ashok Kumar NAYAK, Bangalore (IN); Lalith KUMAR, Bangalore (IN)

(21) Appl. No.: 18/799,620

(22) Filed: Aug. 9, 2024

(30) Foreign Application Priority Data
Aug. 11, 2023 (IN) 202331054133
Sep. 28, 2023 (IN) 202331065115
Jul. 11, 2024 (GB) 2410142.0

(51) Int. Cl. H04W 48/18; H04M 15/00; H04W 12/06

(52) U.S. Cl. CPC H04W 48/18; H04M 15/66; H04W 12/06

(57) ABSTRACT

The disclosure relates to a 5G or 6G communication system for supporting a higher data transmission rate. Disclosed is a method of performing slice management in a telecommunication network, wherein if a current slice is to be replaced by a replacement slice via a replacement procedure, the telecommunication network verifies if the current slice is undergoing or scheduled to undergo an authentication procedure, and if so, the replacement procedure is halted and the authentication procedure is progressed.

### CROSS-REFERENCE TO RELATED APPLICATIONS

This application is based on and claims priority under 35 U.S.C. § 119 to Indian Provisional Patent Application No. 202331054133 filed on Aug. 11, 2023, and Indian Provisional Patent Application No. 202331065115, filed Sep. 28, 2023, in the Indian Intellectual Property Office, and United Kingdom Patent Application No. 2410142.0, filed Jul. 11, 2024, in the United Kingdom Intellectual Property Office, the disclosure of which are incorporated by reference herein in their entirety.

### BACKGROUND

### 1. Field

The present disclosure relates to management of slices in a telecommunication network. The present disclosure relates, in particular, to methods for replacing slices in certain circumstances. Embodiments of the disclosure find particular utility in fifth generation (5G) networks.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

It is an aim of an embodiment of the present disclosure to address the problems identified herein, as well as other problems not mentioned.

According to the present disclosure there is provided an apparatus and method as set forth in the appended claims. Other features of the disclosure will be apparent from the dependent claims, and the description which follows.

According to a first aspect of the present disclosure, there is provided a method performed by an access and mobility management function (AMF) entity for performing slice management in a wireless network, the method comprising: performing a first network slice-specific authentication and authorization (NSSAA) procedure for a single-network slice selection assistance information (S-NSSAI); receiving, a notification for the S-NSSAI including an alternative S-NSSAI to replace the S-NSSAI for a network slice replacement; based on the notification, determining the S-NSSAI to be replaced with the alternative S-NSSAI; performing a second NSSAA procedure for the alternative S-NSSAI unaffected by the network slice replacement.

According to a second aspect of the present disclosure, there is provided an access and mobility management function (AMF) entity for performing slice management in a wireless network, the AMF entity comprising: a transceiver; and at least one processor configured to: perform a first network slice-specific authentication and authorization (NSSAA) procedure for a single-network slice selection assistance information (S-NSSAI), receive, a notification for the S-NSSAI including an alternative S-NSSAI to replace the S-NSSAI for a network slice replacement, based on the notification, determine the S-NSSAI to be replaced with the alternative S-NSSAI, perform a second NSSAA procedure

During an NSSAA procedure, any network slice replacement for an S-NSSAI may be put on hold until NSSAA is completed.

Although a few preferred embodiments of the present disclosure have been shown and described, it will be appreciated by those skilled in the art that various changes and modifications might be made without departing from the scope of the disclosure, as defined in the appended claims.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a better understanding of the disclosure, and to show how embodiments of the same may be carried into effect, reference will now be made, by way of example only, to the accompanying diagrammatic drawings in which:

FIG. 1 illustrates a flowchart of a method for slice management according to various embodiments of the present disclosure.

### DETAILED DESCRIPTION

The 5G system (5GS) supports network slice replacement and network slice instance replacement.

The network slice replacement feature is used to replace a slice (identified by S-NSSAI) with an alternative slice (S-NSSAI) when an S-NSSAI becomes unavailable or congested. The network slice replacement may be triggered in the following cases.

In one example of cases, if the network slice selection function (NSSF) detects that an S-NSSAI becomes unavailable or congested (e.g., based on operations, administration and maintenance (OAM) or network data analytic function (NWDAF) analytics output), the NSSF sends a network slice availability notification for the S-NSSAI to the AMF. The notification may include an alternative S-NSSAI which can be used by the access and mobility management function (AMF) to replace the S-NSSAI. The NSSF notifies the AMF when the S-NSSAI is available again.

In another example of cases, if the policy control function (PCF) detects that an S-NSSAI becomes unavailable or congested for a UE (e.g., based on OAM or NWDAF analytics output), the PCF sends access and mobility related policy notification to the AMF. The notification may include an alternative S-NSSAI which can be used by the AMF to replace the S-NSSAI. The PCF notifies the AMF when the S-NSSAI is available again for the UE.

In yet another example of cases, the OAM sends a notification to AMF when an S-NSSAI becomes unavailable or congested (and also when this S-NSSAI becomes available again) and provides the alternative S-NSSAI to AMF.

Based on the notification above from NSSF or PCF or OAM, the AMF may determine that an S-NSSAI is to be replaced with alternative S-NSSAI. For roaming case, the AMF may receive network slice availability notification of the HPLMN S-NSSAI from NSSF in the HPLMN via NSSF in VPLMN, to trigger the network slice replacement of the HPLMN S-NSSAI as described in 3GPP standard specification.

NOTE 1: It is recommended that, the operator configures to use only one mechanism when triggering the network slice replacement for S-NSSAI.

The AMF determines the alternative S-NSSAI for a UE registered with the S-NSSAI based on the notification from NSSF or PCF, or based on local configuration if the NSSF or PCF do not provide an alternative S-NSSAI. The alternative S-NSSAI may be supported in the UE registration Area. If AMF cannot determine the alternative S-NSSAI for the S-NSSAI, e.g., PCF or NSSF does not provide alternative S-NSSAI, the AMF may further interact with the PCF to determine the alternative S-NSSAI. The event trigger in AMF for interacting with PCF is described in 3GPP standard specification.

The UE indicates the support of network slice replacement feature during the UE registration procedure. For supporting UE in a CM-CONNECTED state and if there is a protocol data unit (PDU) sessions in the UE context associated with the S-NSSAI that needs to be replaced, the AMF provides the alternative S-NSSAI for this S-NSSAI in the allowed NSSAI and in the Configured NSSAI, if not included yet, and the mapping between S-NSSAI(s) to alternative S-NSSAI(s) to the UE in a UE configuration update message as following examples.

In one example, for non-roaming UEs, the AMF provides the mapping of the S-NSSAI to the alternative S-NSSAI to the UE.

In another example, for roaming UEs when the VPLMN S-NSSAI may be replaced by a VPLMN alternative S-NSSAI, the AMF provides the mapping of the VPLMN S-NSSAI to the alternative VPLMN S-NSSAI to the UE.

In yet another example, for roaming UEs when the HPLMN S-NSSAI may be replaced by an alternative HPLMN S-NSSAI, the AMF provides the mapping of the HPLMN S-NSSAI to the alternative HPLMN S-NSSAI to the UE.

NOTE 2: The alternative S-NSSAI or alternative HPLMN S-NSSAI may not be part of the subscribed S-NSSAI as long as they can be mapped to a HPLMN S-NSSAI that is part of the subscribed S-NSSAIs.

For the supporting UE in a CM-IDLE state, when the UE establishes a NAS signalling connection, e.g., through a service request procedure or through a UE registration procedure, if the AMF determines that the S-NSSAI is to be replaced and there is a PDU session associated with the S-NSSAI in the UE context, the AMF sends the mapping of the S-NSSAI to the alternative S-NSSAI to the UE in the UE configuration update message or in the registration accept message.

NOTE 3: It is left to AMF local policy whether to send the mapping of the S-NSSAI to the alternative S-NSSAI to the UE when there is no PDU session associated with the S-NSSAI or wait and send the mapping of the S-NSSAI to the alternative S-NSSAI to the UE when the UE establishes a PDU session associated with the S-NSSAI.

During a new PDU session establishment procedure towards an S-NSSAI, following operation may be performed.

In one example, if the UE is provided with the mapping of the S-NSSAI to an alternative S-NSSAI, the UE provides both the alternative S-NSSAI and the S-NSSAI in the PDU session establishment message. When the AMF receives the alternative S-NSSAI and the S-NSSAI in the PDU session establishment message, or when the AMF receives only the S-NSSAI in the PDU session establishment message, the AMF determines that the S-NSSAI is to be replaced with the alternative S-NSSAI, the AMF includes both the alternative S-NSSAI and the S-NSSAI to the session management function (SMF).

In another example, if the UE is not provided with the mapping of the S-NSSAI to the alternative S-NSSAI, the UE provides the S-NSSAI in the PDU session establishment message. When the AMF determines that the requested S-NSSAI is to be replaced with the alternative S-NSSAI and if the UE supports network slice replacement, the AMF performs a UE configuration update procedure to reconfigure the UE with the alternative S-NSSAI. The AMF continues the PDU session establishment procedure with the alternative S-NSSAI and provides both the alternative S-NSSAI and the S-NSSAI to the SMF.

The SMF proceeds with the PDU session establishment using the alternative S-NSSAI. The SMF sends the alternative S-NSSAI to NG-RAN in N2 SM information and to a UE in a PDU session establishment accept message.

For existing PDU session associated with an S-NSSAI that is replaced with the alternative S-NSSAI, after the AMF sends mapping of the S-NSSAI to the alternative S-NSSAI to the supporting UE in a UE configuration update message, the AMF sends updates to the SMF of the PDU session, e.g., triggering Nsmf_PDUSession_UpdateSMContext service operation, that the PDU session is to be transferred to alternative S-NSSAI and includes the alternative S-NSSAI as showing in following examples.

In one example, if the SMF determines that the PDU session needs to be retained (e.g., if the anchor UPF can be reused with the alternative S-NSSAI and SSC mode 1), the SMF sends the alternative S-NSSAI to the UPF in the N4 message, to the NG-RAN in the N2 message and to the supporting UE in a PDU session modification command message.

In another example, if the SMF determines that the PDU session needs to be re-established, the SMF sends the alternative S-NSSAI to the supporting UE either in PDU session modification command if the PDU session is of SSC mode 3, or in PDU session release if the PDU session is of SSC mode 2 or SSC mode 1, to trigger the re-establishment of the PDU session. The UE includes both, the S-NSSAI and the alternative S-NSSAI in the PDU session establishment message.

When the AMF is notified that the S-NSSAI is available again or the congestion of the S-NSSAI has been mitigated, if the AMF has configured the supporting UE with the alternative S-NSSAI, and the AMF determines for the UE to use the S-NSSAI again, the AMF reconfigures the supporting UE (e.g., by using a UE configuration update message) to use the S-NSSAI. If there is an existing PDU session associated with the alternative S-NSSAI, the AMF sends updates to the SMF of the PDU session, e.g., triggering Nsmf_PDUSession_UpdateSMContext service operation, that the PDU session is to be transferred to the S-NSSAI.

During a handover procedure, if an S-NSSAI may be replaced with an alternative S-NSSAI, the handover procedure (including any PDU session associated with the S-NSSAI to be replaced) may continue unaffected by the network slice replacement. Any network slice replacement for the S-NSSAI may not take place during the handover.

The network slice instance replacement is used when a PDU session for a given S-NSSAI is established using a selected network slice instance and the S-NSSAI corresponding to this setwork slice instance is associated with multiple setwork slice instances. In this case, the network may change the network slice instance for the S-NSSAI if the selected network slice instance is no longer available (e.g., due to overload). The AMF may subscribe with the NSSF for notifications when any of the network slice instances served by the AMF is congested or no longer available.

In case of roaming, the NSSF of VPLMN subscribes with the NSSF of the HPLMN for notifications. When the NSSF notifies the AMF that a network slice instance is congested or no longer available, for some of PDU sessions associated with the network slice instance that is no longer available, the AMF may delete old NSI ID corresponding to the network slice instance that is no longer available and the SMF of the PDU session(s) selected by using such old NSI ID is informed by the AMF to release the PDU session(s). Subsequently, the SMF triggers the impacted UE(s) to establish new PDU session(s) associated with the same S-NSSAI as described in 3GPP standard specification for PDU session(s) of SSC Mode 2 and SSC Mode 3. The AMF selects a new network slice instance for the given S-NSSAI during PDU session establishment.

From the above, it can be seen that one of the main reasons that a slice may be replaced is either when the slice is unavailable, or the slice is congested. However, it is not clear if the congestion is based on control plane congestion or user plane congestion.

The 5GS supports the transport of data over the control plane for a UE which is using control plane cellular Internet o Things (CIoT) 5GS optimization as described in 3GPP standard specification.

Data over non-access stratum (NAS)—or data over the control plane (CP)—is sent by a UE using the control plane service request (CPSR) message (when the UE is in a 5GMM-IDLE mode) or the UL NAS TRANSPORT message (when the UE is in a 5GMM-CONNECTED mode).

In some cases, a PDU session is deemed to be established as control plane only i.e., the session can never be switched to user plane, or the session may never admit user plane resources. Such a PDU session is identified by the inclusion of the control plane only indication in the PDU session establishment accept message which is sent by the SMF to the UE.

The 5GS supports network slice-specific authentication and authorization (NSSAA) as described in 3GPP standard specification. This occurs with a participation of the UE, the AMF and an external authentication, authorization and accounting (AAA) server.

After a slice is authenticated and authorized, the AAA server may perform re-authentication for the slice or S-NSSAI in question. Therefore, it may be noted that an S-NSSAI may be subject to another NSSAA procedure even after the slice has already succeeded an NSSAA procedure.

A first problem with the prior art is a lack of other solutions when a slice is congested at the user plane level. It is most likely the case that the congestion is at the user plane level as otherwise control plane congestion may mean that an SMF is congested, and this aspect is not listed in the description from 3GPP standard specification. Even if it is not always the case, it is safe to assume that congestion can occur at the user plane level and hence the need for slice replacement arises. The prior art solution to congestion is to replace a slice or a slice instance. However, this is not the only solution, especially if the congestion is at the user plane level. Alternative solutions can be devised for this problem and seeking an alternative is one aim of an embodiment of the disclosure.

A second problem is the handling of ongoing NSSAA procedure and slice replacement procedure. As stated in 3GPP standard specification: “during a handover procedure, if an S-NSSAI has to be replaced with an alternative S-NSSAI, the handover procedure (including any PDU session associated with the S-NSSAI to be replaced) may continue unaffected by the network slice replacement. Any network slice replacement for the S-NSSAI may not take place during the handover.”

However, it is also possible that the slice replacement may be triggered when there is an ongoing NSSAA procedure. It is not clear how the network should behave in this regard i.e., whether to perform the procedures together or put one of them on hold.

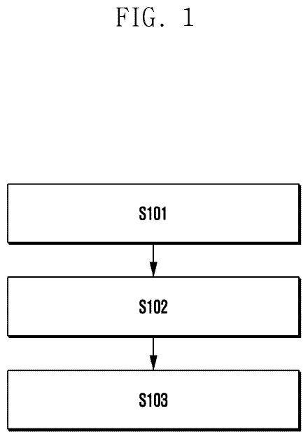

FIG. 1, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

According to a first embodiment of the present disclosure, the network accepts PDU sessions as control plane only when congestion occurs.

The network may determine that a slice is congested, optionally due to user plane congestion, but may also be due congestion at the control plane. Hereafter, the term congested may refer to user plane congestion only, or control plane congestion only, or user plane congestion and control plane congestion, or other forms of congestion. The determination may be based on a trigger for network slice replace as has been described in 3GPP standard specification, where the AMF may be notified of a slice being unavailable or congested by the NSSF, or the PCF, based on OAM. The determination may also be because of an alternative S-NSSAI be provided to the AMF or by the AMF determining to use an alternative S-NSSAI using any mechanism.

When any of the above occurs, using any methods e.g. the AMF determines that a slice is unavailable or is congested, where optionally the congestion is on the user plane level, the AMF may then decide to permit the establishment of new PDU sessions such that these PDU sessions are to be established as control plane only sessions or as control plane sessions (i.e., not necessarily being control plane only sessions).

As such, when the AMF receives a new request for a PDU session e.g., the AMF receives an UL NAS TRANSPORT message which carries a 5GSM message and optionally the request type indicates that the request is an initial request, i.e., the request is for a new PDU session, even though the associated slice is experiencing congestion (optionally at the user plane level), the AMF may accept the request and forward the 5GSM message to the SMF which is associated with the S-NSSAI in question (whether the S-NSSAI is selected by the AMF or the UE). However, the AMF may indicate to the SMF that the PDU session may be established as control plane only i.e., the AMF includes the control plane only indicator to the SMF. Similarly, the SMF may accept the PDU session as control plane only and indicate to the UE (in the PDU session establishment accept message) that the session is established for a control plane only.

In another alternative, the AMF may accept the request and forward the 5GSM message to the SMF but indicates that the session may be established as a session for control plane CIoT optimization i.e., as a session which uses control plane to send the data however not as a control plane only session. Moreover, whilst the congestion is ongoing or the AMF determines that the S-NSSAI in question is congested, any subsequent request to establish the user plane resources for this session may be rejected by the network (e.g., the AMF). The AMF may use any 5GMM cause value to indicate the reason for rejection. For example, the AMF may use 5GMM cause value #92 “insufficient user-plane resources for the PDU session.”

Note that the network (e.g., AMF or SMF) may be configured to accept a certain number of PDU sessions as control plane only sessions i.e., the provided embodiments may be for a certain well-known number of PDU sessions that can be established as control plane only (or as control plane). When this maximum is reached, the network may then revert to apply slice replacement mechanism.

When the AMF determines that the congestion is alleviated, or the slice is available, the network (e.g., AMF and/or SMF) may then accept a new request for PDU sessions as normal requests i.e., as requests with user plane accordingly.

Note that the technique set out here can also apply for the case when the network determines to apply a maximum number of established PDU sessions for a slice in question. As such, the network (AMF or SMF or network slice admission control function (NSACF)) may be configured to exempt a PDU session that is based on a control plane (but not control plane only), or to exempt a PDU session that is to be used for a control plane only, from network slice admission control optionally where the admission control may be based on any criterion such as a maximum quota on the number of PDU sessions that can be established.

As such, when the quota is reached, the network may be configured to allow new PDU sessions as PDU sessions that can be used for control plane data transfer (but not as control plane only), or as PDU sessions for control plane only (with a session which is associated with the control plane only indicator).

The details above can be applied for any UE or for UEs which indicate the support of control plane CIoT 5GS optimization (e.g., in the 5GMM capability IE) and/or for networks which indicate the support of (and/or allowance for a UE to use) control plane CIoT 5GS optimization (e.g., in the 5GS network feature support IE).

The details set out above can be applied by an AMF, SMF or NSACF or any network function or any combination of network functions.

A second embodiment relates to AMF behaviour for slice replacement during an NSSAA procedure.

The AMF may not perform slice replacement during an ongoing NSSAA procedure optionally for the S-NSSAI that has to be replaced and for which NSSAA is ongoing. As such, if there is an ongoing NSSAA procedure for an S-NSSAI and the AMF needs to trigger or perform slice replacement for the same S-NSSAI, then the AMF may wait until the NSSAA procedure is completed before performing the slice replacement.

As such, during an ongoing NSSAA procedure for an S-NSSAI, if the S-NSSAI (for which NSSAA is ongoing) has to be replaced with an alternative S-NSSAI, the NSSAA procedure (including any PDU session associated with the S-NSSAI to be replaced) may continue unaffected by the network slice replacement. Any network slice replacement for the S-NSSAI may not take place during the NSSAA procedure.

In one alternative, if the UE is aware of an ongoing NSSAA for an S-NSSAI, and the UE receives an alternative S-NSSAI that is mapped to the S-NSSAI for which NSSAA is ongoing, the UE may not initiate the establishment of a new PDU session for the alternative S-NSSAI until the ongoing NSSAA is completed (optionally where the S-NSSAI that the alternative S-NSSAI is associated with is an S-NSSAI for which NSSAA is ongoing), or optionally until the NSSAA is completed and is successful. For example, the NSSAA may be deemed to be successful if the related S-NSSAI is not removed from the allowed NSSAI or is not in the rejected NSSAI. As such, the establishment of a new PDU session for an alternative S-NSSAI may not be performed (e.g., by a UE) if there is an associated S-NSSAI for which NSSAA is ongoing.

Therefore, the UE may verify a new condition when determining to establish a new PDU session for an alternative S-NSSAI. The condition is to verify if there is an associated S-NSSAI (i.e., an S-NSSAI which is associated with the alternative S-NSSAI) for which NSSAA is ongoing. If yes, then the UE may not establish a new PDU session for the alternative S-NSSAI (optionally until the NSSAA completes or completes successfully). If not, then the UE can establish a new PDU session for the alternative S-NSSAI.

In one alternative, the NSSAA may be continued along with the slice replacement procedure with an alternative S-NSSAI. Once the NSSAA is completed, if the procedure is successful, then the network provides the alternative S-NSSAI in the allowed NSSAI (if not already provided) or provides the alternative S-NSSAI to the UE in the allowed NSSAI.

If the NSSAA fails for the existing S-NSSAI, the network may perform NSSAA for the alternative S-NSSAI. Or the network may remove the alternative S-NSSAI from the allowed NSSAI if the alternative S-NSSAI has already been provided to the UE in the allowed NSSAI. The existing S-NSSAI may also be removed from the allowed NSSAI if the NSSAA procedure fails for this S-NSSAI.

For completeness, FIG. 1 illustrates a method for slice management according to various embodiments of the present disclosure.

It illustrates a method of performing slice management in a telecommunication network.

At S101, it is determined if a current slice is to be replaced by a replacement slice via a replacement procedure. At S102, the telecommunication network verifies if the current slice is undergoing an authentication procedure, and if so, at S103 the replacement procedure is halted.

At least some of the example embodiments described herein may be constructed, partially or wholly, using dedicated special-purpose hardware. Terms such as “component,” “module,” or “unit” used herein may include, but are not limited to, a hardware device, such as circuitry in the form of discrete or integrated components, a field programmable gate array (FPGA) or application specific integrated circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an access and mobility management function (AMF) entity for performing slice management in a wireless network, the method comprising:
performing a first network slice-specific authentication and authorization (NSSAA) procedure for a single-network slice selection assistance information (S-NSSAI);
receiving, a notification for the S-NSSAI including an alternative S-NSSAI to replace the S-NSSAI for a network slice replacement;
based on the notification, determining the S-NSSAI to be replaced with the alternative S-NSSAI; and
performing a second NSSAA procedure for the alternative S-NSSAI unaffected by the network slice replacement.

2. The method of claim 1, wherein in case that the S-NSSAI is determined to be replaced with the alternative S-NSSAI during the first NSSAA procedure for the S-NSSAI.

3. The method of claim 1, further comprising:
identifying whether the second NSSAA procedure for the alternative S-NSSAI is completed as success; and
in case that the second NSSAA procedure for the alternative S-NSSAI is completed as success, performing the network slice replacement.

4. The method of claim 1, wherein the notification is a network slice availability notification received from a network slice selection function (NSSF).

5. The method of claim 1, wherein the notification is access and mobility related policy notification received from a policy control function (PCF).

6. The method of claim 1, wherein the notification is received from an operation, administration, and maintenance (OAM).

7. The method of claim 1, further comprising:
dropping a session associated with a current slice,
wherein the current slice requires a replacement based on a congestion status on at least one of a user plane (UP) or a control plane (CU), and
wherein the current slice comprises a plurality of protocol data unit (PDU) sessions.

8. An access and mobility management function (AMF) entity for performing slice management in a wireless network, the AMF entity comprising:
a transceiver; and
at least one processor configured to:
perform a first network slice-specific authentication and authorization (NSSAA) procedure for a single-network slice selection assistance information (S-NSSAI),
receive, a notification for the S-NSSAI including an alternative S-NSSAI to replace the S-NSSAI for a network slice replacement,
based on the notification, determine the S-NSSAI to be replaced with the alternative S-NSSAI, and
perform a second NSSAA procedure for the alternative S-NSSAI unaffected by the network slice replacement.

9. The AMF entity of claim 8, wherein in case that the S-NSSAI is determined to be replaced with the alternative S-NSSAI during the first NSSAA procedure for the S-NSSAI.

10. The AMF entity of claim 8, wherein the at least one processor is further configured to:
identify whether the second NSSAA procedure for the alternative S-NSSAI is completed as success; and
in case that the second NSSAA procedure for the alternative S-NSSAI is completed as success, perform the network slice replacement.

11. The AMF entity of claim 8, wherein the notification is a network slice availability notification received from a network slice selection function (NSSF).

12. The AMF entity of claim 8, wherein the notification is access and mobility related policy notification received from a policy control function (PCF).

13. The AMF entity of claim 8, wherein the notification is received from an operation, administration, and maintenance (OAM).

14. The AMF entity of claim 8, wherein the at least one processor is further configured to:
drop a session associated with a current slice,
wherein the current slice requires a replacement based on a congestion status on at least one of a user plane (UP) or a control plane (CU), and
wherein the current slice comprises a plurality of protocol data unit (PDU) sessions.
